(19) United States
(12) Patent Application Publication
(10) Pub. No.: US 2006/0159421 A1
(43) Pub. Date: Jul. 20, 2006

(54) Reservation video recording method using position on the paper and recording apparatus

(76) Inventors: Hiroko Sukeda, Tokorozawa (JP); Seiki Mizutani, Matsudo (JP); Youichi Horii, Mitaka (JP); Takeshi Hoshino, Kodaira (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/315,223

(22) Filed: Dec. 23, 2005

(30) Foreign Application Priority Data
Jan. 19, 2005 (JP) 2005-11039

(51) Int. Cl. H04N 5/91

(52) U.S. Cl. 386/83

(57) ABSTRACT

A method and system are provided which, in a program recording apparatus which performs recording of television programs, enable even those users who are inexperienced in operating machines to simply, directly and flexibly perform a program recording reservation operation and a recorded program viewing operation. An association is first made between position information on a paper or sheet with program information, and the user inputs a program specification using a program schedule and a digital pen. The information input by the pen is converted to program information, and a program recording reservation is made. If the recorded program list is printed out or various content lists are used, program playback and content management can be performed with greater ease.

### CLAIM OF PRIORITY

The present application claims priority from Japanese patent application P2005-11039 filed on Jan. 19, 2005, the content of which is hereby incorporated by reference into this application.

### BACKGROUND OF THE INVENTION

The present invention relates to a recording apparatus for recording a broadcasting signal of a television program to a recording medium, and in particular, a recording apparatus and recording method which designate a program to be reserved for recording and to be viewed by using a digital pen.

Program recording apparatus for recording a television program on a hard disk, DVD (Digital Versatile Disk) or videotape are widely used. To specify recording of a specific program beforehand, it is required to make a recording reservation. Various means are used to make a complicated recording reservation simpler.

One of these methods, disclosed in U.S. Pat. No. 5,974,222 B2, is to use a number sequence known as a G code. The G code replaces the four elements of recording date, channel, program start time and program length by a number of up to eight digits, and permits recording reservation to be performed. When the user inputs this number sequence by remote control or other means and it is transmitted to the recording apparatus, it is decoded in the recording apparatus, and the desired program is reserved.

Another example of a technique that simplifies recording reservation has been put to practical use recently by the EPG (Electric Program Guide), as disclosed in JP 2,838,892 B2 and JP H1-307944 A1. EPG is a system that displays a program schedule on a television screen. Program schedule data may be sent out using the gaps between radio waves and received by a special terminal, or a network terminal connected to the television is used. A videocassette recorder which can make a recording reservation based on the EPG data has also been put into practical use.

Due to multi-tuner installations which can record plural stations simultaneously, and increased capacities of recording media for recording programs, it is now possible to record many programs simultaneously. Consequently, it is now becoming increasingly popular, instead of selecting a program which it is desired to record, to record a large number of programs by first inputting keywords and other conditions, and then select the desired program later from among these. In other words, instead of watching television at the program broadcast time as before, the user can now freely decide how to watch programs and in what sequence.

In WO 01/71473A1, a pen type input apparatus known as a digital pen is described which has come into practical use. This acquires the trace of a pen nib electronically and inputs it to an electronic computer, such as the “Anoto pen” developed by the Swedish company Anoto. A digital pen has the advantage that it can easily be used even by a user unfamiliar with the use of a keyboard or mouse, and it is expected to be useful when making applications to electronic governments or for other purposes.

### SUMMARY OF THE INVENTION

In the related art method of using a G code to reserve recordings, the user needs to input a line of up to eight digits manually by an input means, such as remote control. It is very troublesome to input a seemingly meaningless sequence of numbers so that they can be converted to program data, input errors occur frequently and often lead to recording reservation errors. In a recording reservation method using EPG, a program schedule is displayed on a screen of a television (or, a personal computer or cellular phone connected to a network) and a desired program is selected from the schedule. Although the program schedule display on the screen is easy to search, there is however a limit to viewing a screen display, and it is difficult to operate successfully by a user who is inexperienced in operating machines.

Moreover, along with the progress made in recording apparatus described above, it is difficult to search desired programs from a large number of recorded programs, and when too many have been recorded, to know which ones are desired.

It is therefore an object of the invention to provide a method and system which permit the scheduling of program recording and the viewing of recorded programs to be performed simply, intuitively and flexibly even by a user who is inexperienced in operating machines.

Television program guides found in newspapers and magazines are widely employed to give information about television programs. These television program guides on paper media are convenient and portable, and since they permit the user to view and consult information at any time, in any location and in any occupation, they are extremely useful.

The aforesaid digital pen makes it possible, while retaining the advantages of these paper media, to provide a means of simply, intuitively and flexibly scheduling recording and viewing programs.

Specifically, an association is first established between a position on paper (or sheet, hereafter “paper”) and program information, and correspondence information is stored on a server via a recording apparatus or network. The user inputs a program specification using this paper with associations and a digital pen. Information about the trace of the pen is converted into program information according to the previously established associations, thus completing specification of the programs it is designed to record or view. By arranging the program sequence specified by the pen to be the desired viewing sequence, the user can view programs in a preferred sequence regardless of the sequence in which they were broadcast. Further, by first making an association between the pattern of motion of the pen and the recording/viewing method, it is also possible to specify the recording method, and the playback sequence/playback speed when the programs are viewed.

These operations, in addition to the viewing of programs, may also be used as tools for managing various content, i.e., not only recorded television programs, but also music files and image/movie data acquired from digital cameras or video cameras, content data stored on media such as DVD/video, CD and the like, or streaming data received from outside via a network. An association is established between the content and position information on paper, and the playback or management of this content is performed using a digital pen.

According to the present invention, there are therefore provided a method and system which permit information to be viewed and consulted in a convenient and portable format at any time, in any location and in any occupation, and which permit the simple, intuitive and flexible scheduling of program recording, viewing of recorded programs and management of various contents.

### BRIEF DESCRIPTION OF THE DRAWINGS

The present invention can be appreciated by the description which follows in conjunction with the following figures, wherein:

FIG. 1 is a schematic diagram of a system according to one embodiment of the invention;

FIG. 2 is a diagram describing the principle of the digital pen used according to this embodiment;

FIG. 3 shows a method (1) of specifying a program with the pen;

FIG. 4 shows a method (2) of specifying a program with the pen;

FIG. 5 shows a procedure for creating program information conversion data;

FIG. 6 shows a procedure for converting pen input data to program information;

FIG. 7 shows the system configuration of the first embodiment;

FIG. 8 shows the construction of a video recorder according to the first embodiment;

FIG. 9 shows the construction of a server according to the first embodiment;

FIG. 10 shows a television program guide issue procedure according to the first embodiment;

FIG. 11 shows a recording reservation procedure according to the first embodiment;

FIG. 12 shows a system configuration of a second embodiment;

FIG. 13 shows a program schedule making procedure according to the second embodiment;

FIG. 14 shows a recording reservation procedure according to the second embodiment;

FIG. 15 shows an example of a screen for program schedule customization;

FIG. 16 shows a system configuration according to a third embodiment;

FIG. 17 shows an example of a program advertising card;

FIG. 18 shows a system configuration according to a fourth embodiment;

FIG. 19 shows a system configuration according to a fifth embodiment;

FIG. 20 shows a system configuration according to a sixth embodiment; and

FIG. 21 shows a system configuration according to a seventh embodiment.

### DETAILED DESCRIPTION OF THE INVENTION

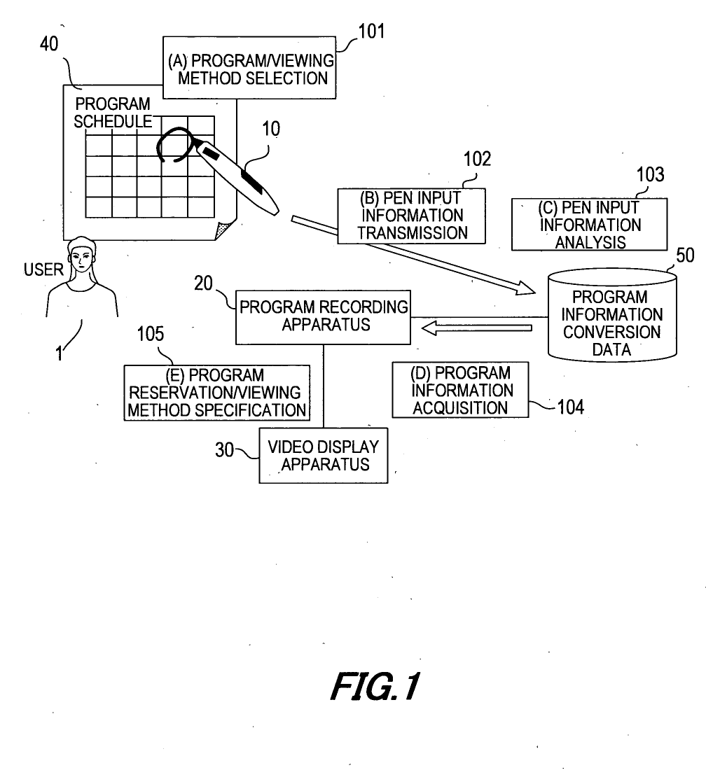

FIG. 1 shows the flow of a system outline implemented by the present invention and rough processing. A user 1 checks a program schedule 40 related to program information by using a digital pen 10, and selects a program to be recorded (101). The relation between the position of the program schedule 40 specified by the pen 10 and program information are stored in a memory beforehand as program information conversion data 50. The trace of the pen used by the user 1, and pen input information such as the nib pressure and input time, are transmitted (102), analyzed (103), and converted to corresponding program information using the program information conversion data 50 (104). This information is used for reserving recordings and specifying the viewing method in a program recording apparatus 20 (105). A display unit 30 is used to display images recorded by reservation according to the aforesaid specification procedure, or display movies selected for viewing by the aforesaid specification procedure.

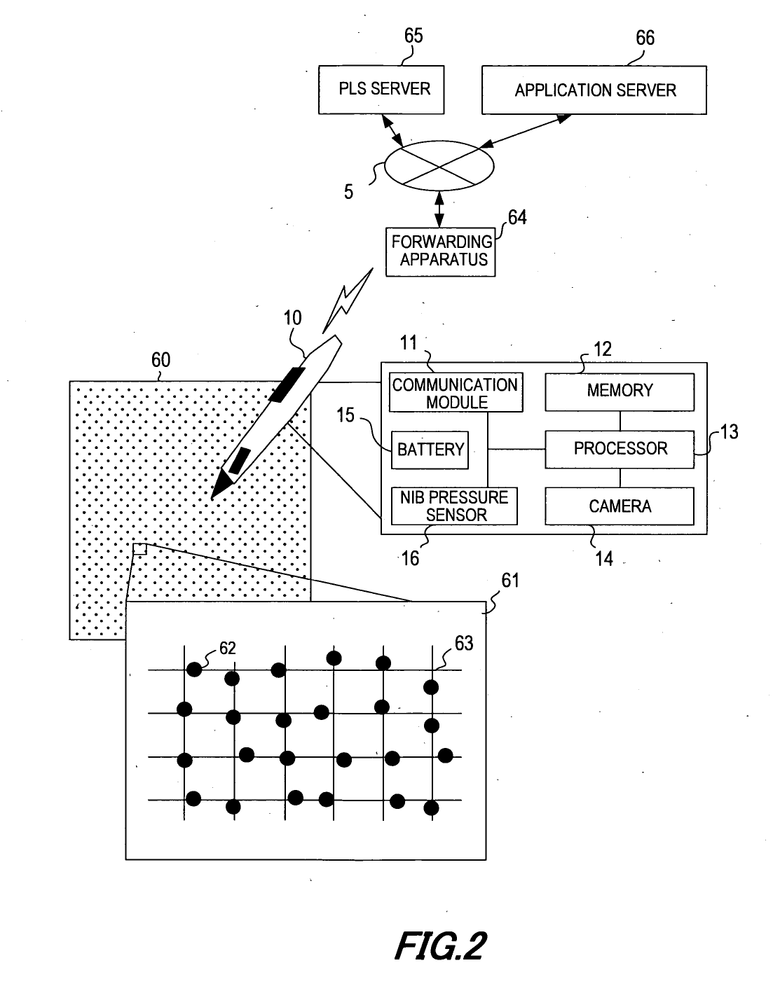

Here, referring to FIG. 2, as one example of the digital pen 10 used in this embodiment of the invention, the digital pen 10 disclosed in WO 01/71473A1 Patent Document 3 will be described.

The digital pen 10 is used with a form 60 that has a mark for detecting a position corresponding to this method. The digital pen 10 comprises a communication module 11, memory 12, processor 13, camera 14, battery 15 and nib pressure sensor 16. Since the digital pen 10 also has an ordinary nib with ink, when something is filled in on paper with this digital pen 10, the information visually remains on the paper.

In the digital pen 10, the image of a pattern for detecting position which is printed on the paper is acquired by the camera 14. Looking at the form 60 in more detail (61), small dots 62 are scattered and printed non-uniformly on the form. These dots are all printed offset to the top, bottom, left or right at a certain distance from the intersections of virtual grid lines 63. Taking a combination of these dots (for example, an area of 6×6), a combination of values of the top, bottom, left and right offsets of these 36 dots gives absolute position information over an expansive plane region.

Positions in a space formed by a combination of offsets can be specified by acquiring an image within a range including the aforesaid plural dot pattern at a constant time interval by the camera 14 with which the digital pen 10 is provided. Details of this principle are clarified by WO00/73983 A1.

The digital pen 10 has a communication interface 11 such as Bluetooth or Universal Serial Bus (USB), and information such as pen the trace and nib pressure is transmitted to a forwarding apparatus 64 such as a personal computer or cellular phone.

The forwarding apparatus 64 communicates with a Paper Look-up Service (PLS) server 65 via a network 5 (e.g., the Internet). When the use of the digital pen 10 starts, the PLS server is associated to the input pen, paper and application. The PLS server receives a pen ID and paper ID, and authenticates the pen. Subsequently, matching is achieved with an application corresponding to the paper, and the URL of an application server 612 is returned.

Due to this processing, an application corresponding to the filled form is launched, and pen input data is correctly sent to the corresponding server. The PLS can also specify coordinates on paper from the dot pattern acquired by the camera 14, and output specified coordinates for the purpose of the application.

The aforesaid coordinate position on paper is specified by the PLS server which is a exclusive server that manages the dot pattern. Further, if information required to specify the paper ID, pen ID, input coordinates and the application is stored beforehand in another apparatus such as a server of a program information center (application server) or a video recorder, the digital pen 10 can be used for the application without accessing the PLS server every time.

There is an advantage that if this digital pen 10 is applied to the present invention, a program printed on the program schedule can be freely specified by the trace that the user traces with the pen. An embodiment using this digital pen 10 will now be described. It will of course be understood that the invention is not limited to this type of digital pen 10, and another input means may be used provided that a position on paper can be specified by user input, and a program can be specified corresponding to the specified position.

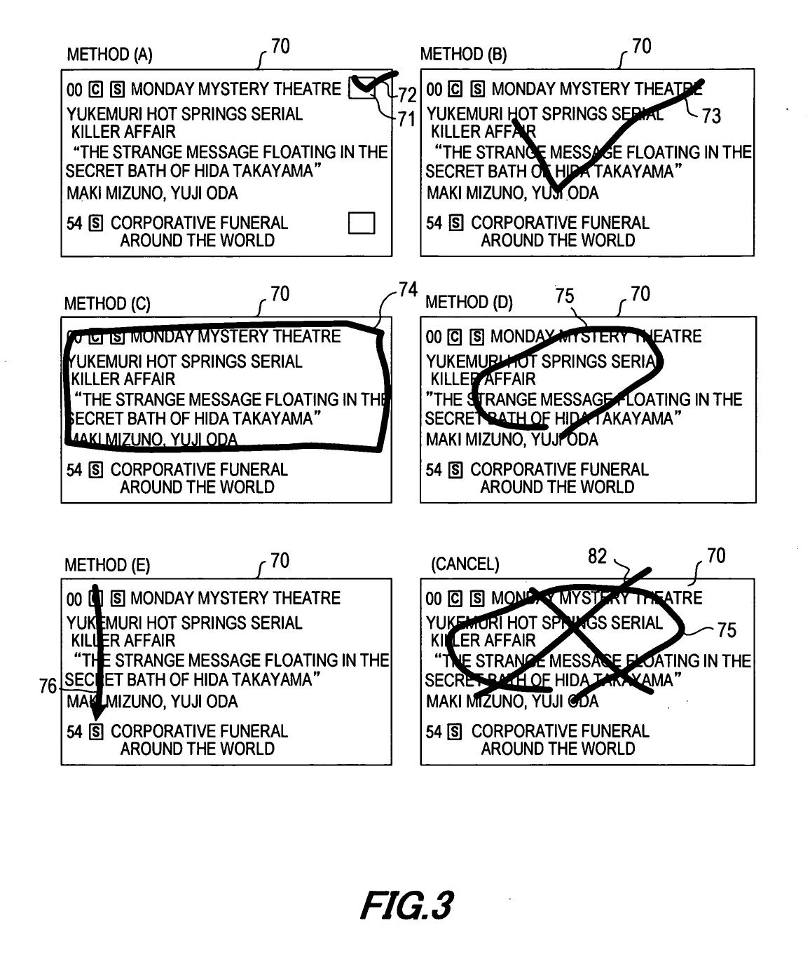

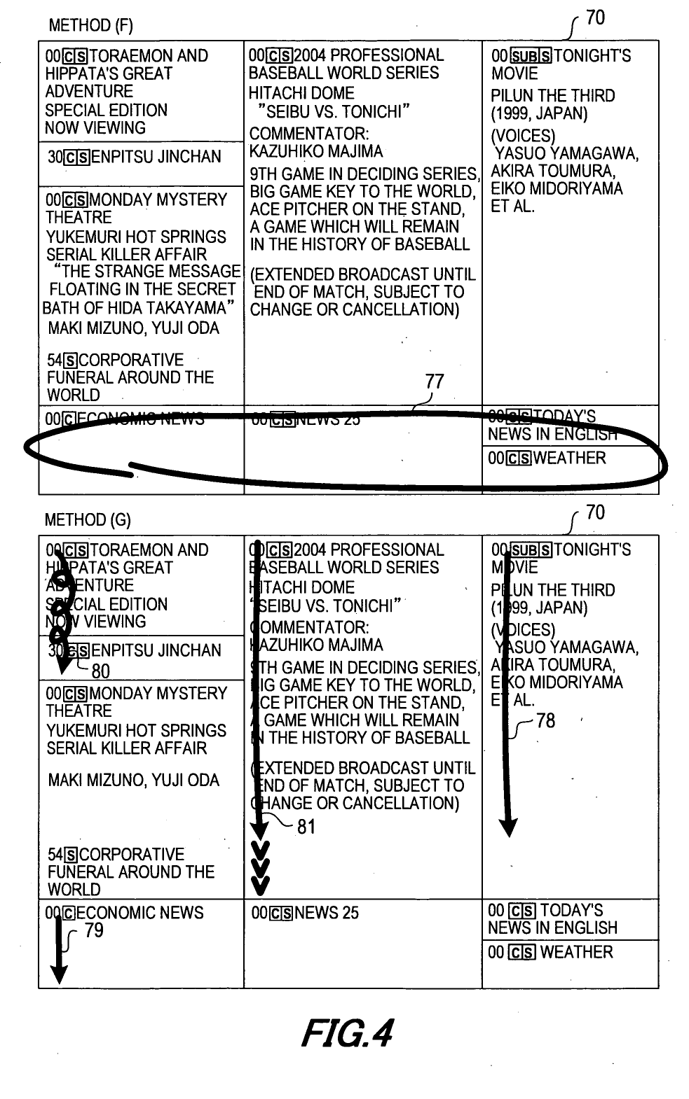

Next, referring to FIG. 3 and FIG. 4, a method of specifying a program by a pen in the system and service of this embodiment will be described.

FIG. 3 shows an example of methods of (commands for) selecting a program from a program schedule 70.

Method (A) is a method wherein, check boxes 71 are printed for each program, and check marks 72 are respectively made in check boxes for the programs it is desired to select. According to method (A), the program to be selected can be selected surely. However, when the program guide is printed, the check boxes must also be printed and the previous layout of the program schedule on paper must be changed.

Method (B) is a method wherein a large check mark 73 is made on program information to be selected. According to method (B), the program can be specified relatively easily. However, there is a problem that when there are many programs of short duration arranged crowdedly, it is difficult to ascertain which program was specified.

Method (C) is a method wherein a program column of the program information to be selected frame is enclosed by a line 74. Method (C) has the advantage that it is easy to ascertain which program was selected, and programs in the same time zone and on the same channel can be specified together (FIG. 4).

Method (D) is a method of marking a circle 75 on the program information to be selected. According to method (D), the user can select the program naturally. This is convenient when specifying plural programs together.

Method (E) is a method of marking an arrow 76 in the time zone of the selected program. This is convenient when selecting consecutive programs together, and the viewing sequence of plural programs is specified (FIG. 4).

To cancel a program selection, the program selection is cancelled by marking a large cross 82 with the pen to cancel the original program selection 75.

FIG. 4 shows an example of a method of selecting plural programs from the program schedule 70.

Method (F) is a method of enclosing program information to be selected by a circle 77. According to method (F), programs in a specific time zone can be specified together. Likewise, programs on the same channel can be specified one after the other.

Method (G) is a method whereby, in addition to reserving a recording, the viewing method is specified. For example, if arrows are marked in the sequence 78, 79, 80, 81 on one program schedule, program playback and the viewing sequence can be specified by the sequence of the arrows.

Further, by making an association between a command specifying the recording method and the viewing method with a pen gesture in advance, not only program recording but also the viewing method can be set according to the user's preferences. For example, the spiral arrow 80 may define fast forward, and the arrow 81 may define recording to the end even though a program was extended.

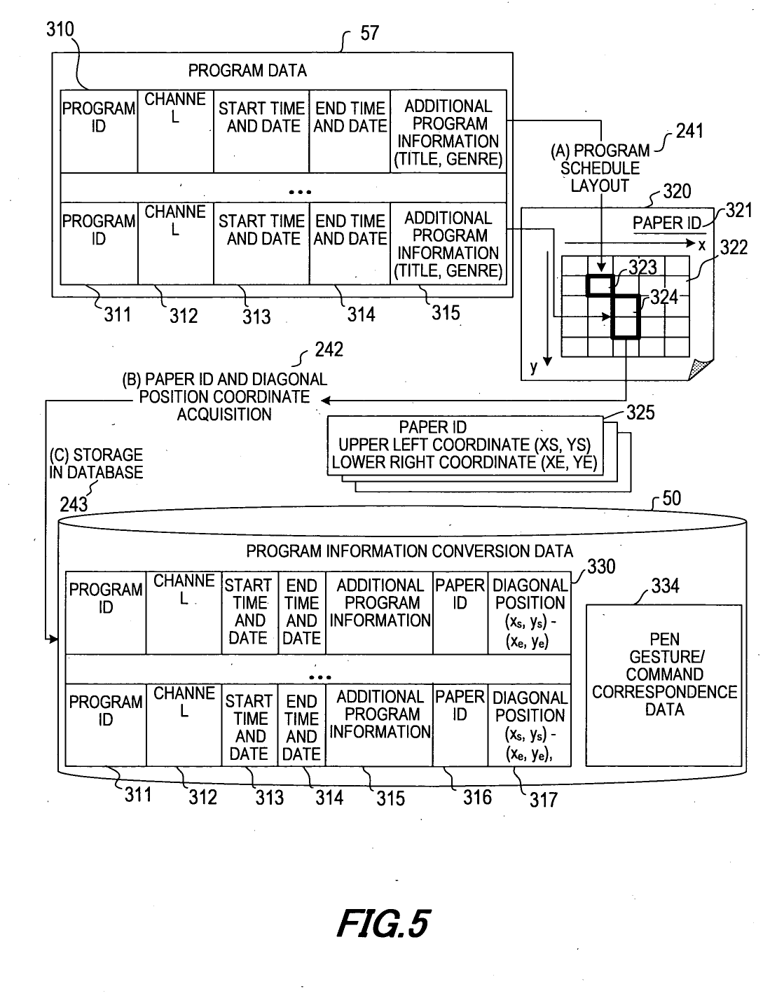

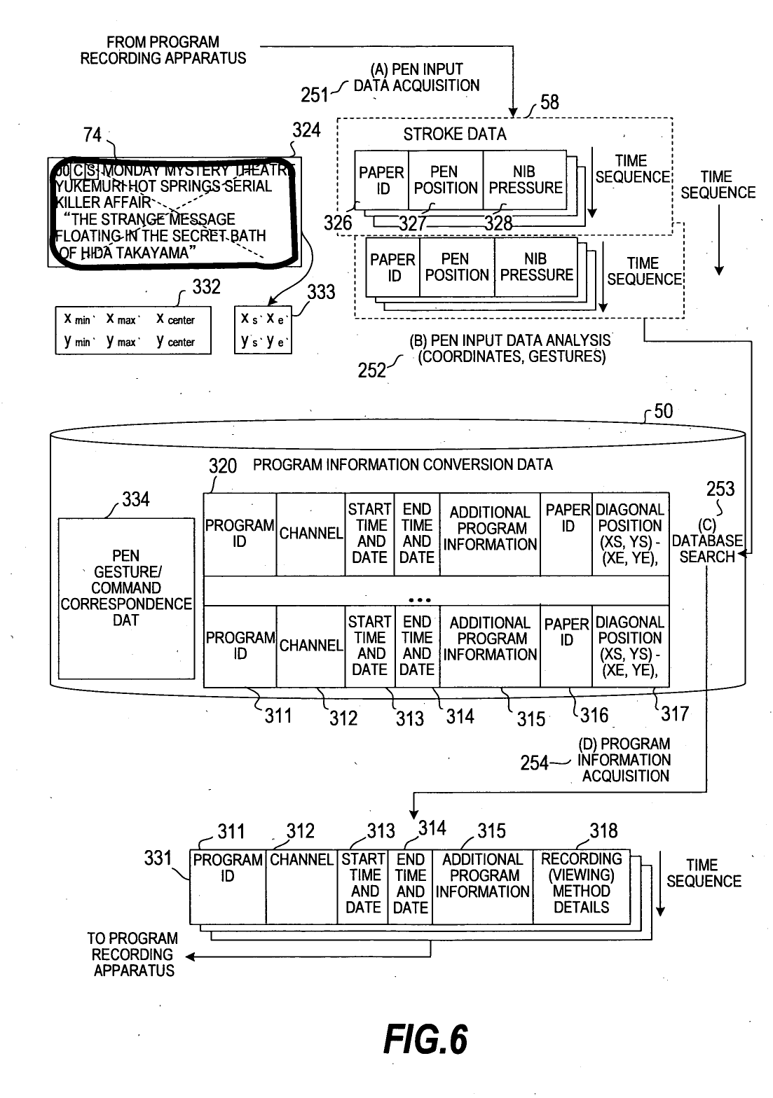

Next, referring to FIG. 5 and FIG. 6, examples of the format of the program information conversion data 50 in FIG. 1, the means for creating data and the means for acquiring program information, will be described

FIG. 5 is one example of a method of creating data for program information conversion. Program data 57 (e.g., EPG data) acquired via a network 5 is a set of individual program information 310. The individual program information 310 includes a program ID 311, channel 312, start time and date 313, end time and date 314 and additional program information 315. The additional program information 315 is information such as the title, genre and performer, etc.

The program information 310 is arranged on the program schedule according to the layout 241. Alternatively, it may be laid out beforehand like a current television program guide. Arranged program arrangement information 320 has a paper ID 321 to distinguish the issue number and page of the program guide, and individual program information 323, 324 is disposed on corresponding X axis and Y axis (322).

From the program layout information, information is acquired as to which program is located at which position on the program schedule and with which paper ID (paper ID and coordinate data set 325) (242), and stored in a database together with the original program information (243).

Information 330, which is a combination of the original program information, paper ID 316 and corner position 317, is stored as the program information conversion data 50. If plural types of command can be used by the pen input shown in FIG. 3 and FIG. 4, data 334 showing associations between pen gestures and commands may be stored beforehand, and used for program specification processing described later. The association data comprising the gestures and commands may be updated by learning the user's habits.

Next, referring to FIG. 6, an example of a method for converting pen input data into program information using the created program information conversion data, will be described.

The pen data input by the methods shown in FIG. 3 and FIG. 4 is stroke data wherein the paper ID 326, pen position 327 and nib pressure 328 arranged in a time series, are collated in a time sequence.

A database is searched by comparing with the coordinates of the program data 320 of the program information conversion data 50 based on the obtained coordinates information (253), and corresponding program information is acquired (254). For example, when pen input data 74 enclosed by a square is obtained for the program frame 324, coordinate information for the region enclosed by the pen (e.g., X axis minimum value: Xmin, X axis maximum value: Xmax, X axis center value: Xcenter, Y axis minimum value: Ymin, Y axis maximum value: Ymax, Y axis center value: Ycenter) 332 is compared with coordinate information for the program frame (upper left coordinates: (Xs,Ys), upper right coordinates: (Xe,Ye)) 333. The data contained within the enclosed region is then searched.

When the pen input data is analyzed, gestures are recognized together with the coordinates (252). A viewing method 318 (e.g., playback speed setting and extended processing, etc.) corresponding to a rule 334 of a predetermined gesture, can be specified. Program data (program ID, channel, start time and date, end time and date, additional program information and recording method (or, viewing method)) 331 converted from the pen input data is then transmitted in a time series to the program recording apparatus.

### FIRST EMBODIMENT

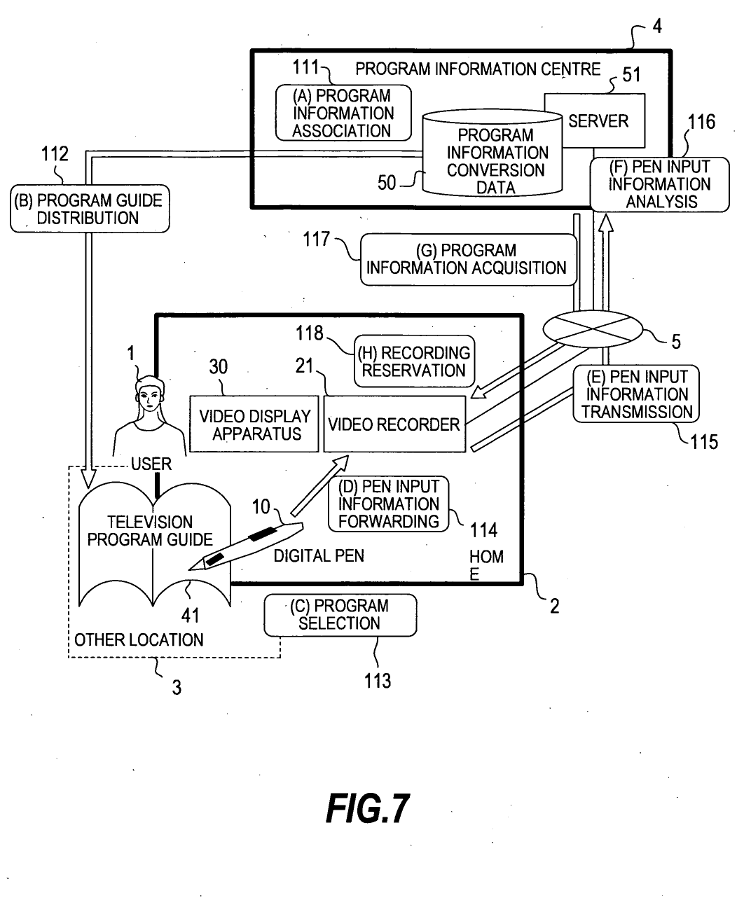

Hereafter, referring to FIG. 7 to FIG. 11, a first embodiment of the present invention will now be described.

FIG. 7 is a system configuration diagram of the first embodiment.

The system of the first embodiment comprises a digital pen 10, a video recorder 21 corresponding to this system, an video display apparatus 30 such as a television or monitor, a television program guide 41 corresponding to this system, a server 51 for providing the whole service and program information conversion data 50.

The video recorder 21 is a program recording apparatus for storing program data on media such as a hard disk drive or DVD. The server 51 and program information conversion data 50 in a program information center 4.

Next, the processing of the service provided by the first embodiment will be described.

(A) In the program information center 4, television program guide information is first printed on a form corresponding to the digital pen 10 used with this system, and associations are made between coordinates and program information on each page of the television program guide 41. The association information is stored in the program information server 51 as program information conversion data 50 (111).

(B) A printed program guide is distributed (112).

(C) The user 1 obtains the television program guide 41, and peruses the obtained television program guide 41 at his home 2 or another location 3. When he finds a program he desires to record, he makes a mark in the relevant program column using the digital pen 10. The program is selected by this mark with the digital pen 10 (113). An example of the program selection method is as described above in FIG. 3 and FIG. 4.

(D) In the program selection operation, data acquired by the digital pen is stored by the digital pen 10, and forwarded to the video recorder 21 corresponding to this system with a suitable timing (114). The communication method used at this time is a wireless communication method such as Bluetooth, or a wired communication method such as USB connected by a wire or the like.

(E) The video recorder 21 accesses the server 51 of the program information center 4 via the network 5, and transmits the information acquired by the digital pen 10 (115).

(F) The server 51 analyzes the information acquired by the digital pen 10 (116), looks up the program information conversion data 50, and converts the information acquired by the digital pen 10 to corresponding program information. Also, if required, pen gesture/command correspondence data 334 is looked up, and pen gestures are converted to commands.

(G) The converted program information is transmitted to the video recorder 21 (117).

(H) The video recorder 21 completes the recording reservation based on the obtained program information (118).

Due to this processing, the user 1 can complete the reservation of a desired program recording simply by selecting the program from the printed program guide and transmitting it to the video recorder. The reservation method of this embodiment differs from the reservation method using a G code since it can select a program by a natural operation. Further, the user can select and reserve plural programs in which he is interested at the same time.

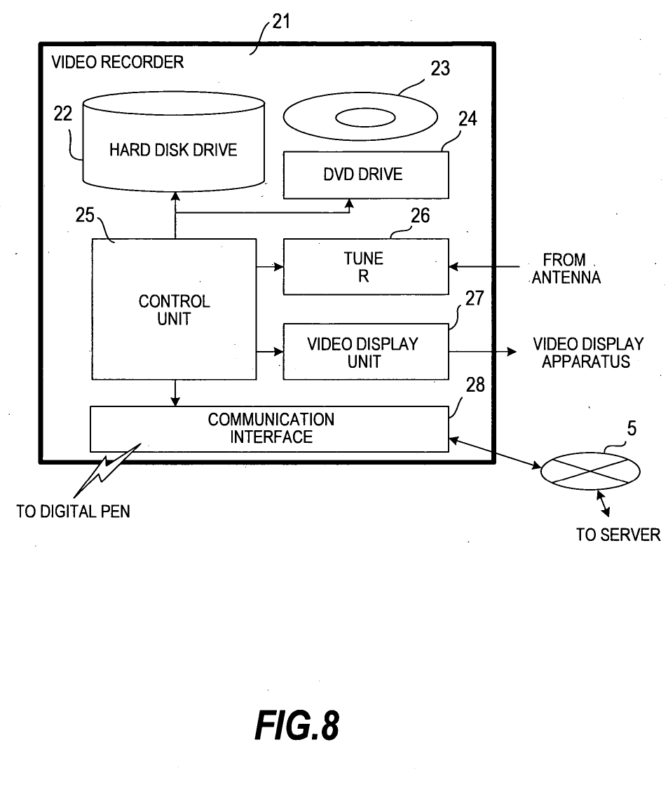

FIG. 8 is the configuration of the video recorder used with this system.

The video recorder 21 comprises a recording medium including a hard disk drive 22, DVD disk 23, DVD disk drive 24, control unit 25, tuner 26, video display unit 27 and communication interface 28.

The hard disk drive 22 stores video, audio and control data for reserving recordings or selecting programs to view. The tuner 26 receives a video signal stored on the storage medium. The video display unit 27 controls an video display apparatus such as a television or monitor. The communication interface 28 is connected with an input device such as the digital pen 10 and with the server 51.

The video display unit may be integrated with the video recorder 21, or it may be another apparatus.

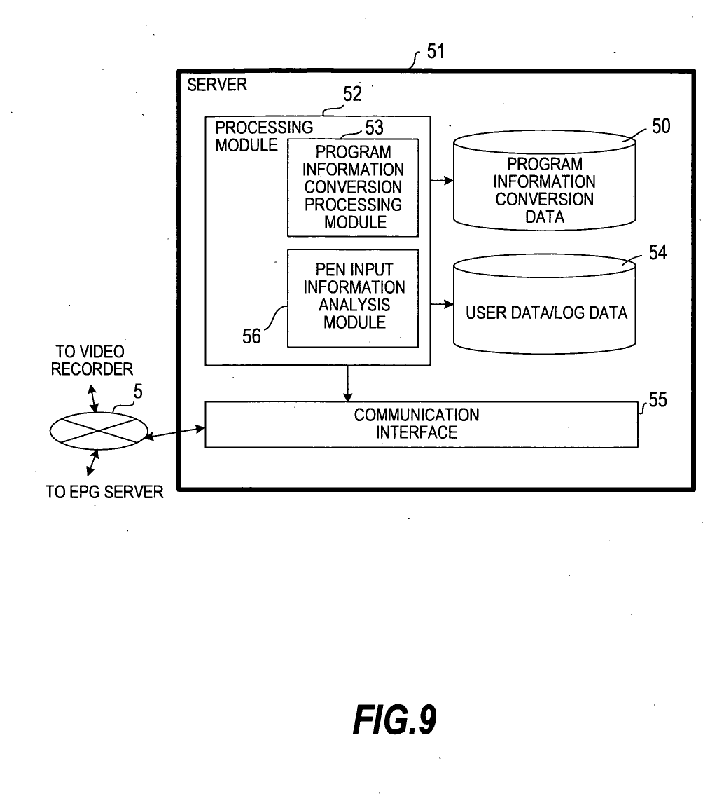

FIG. 9 shows the configuration of the server in the first embodiment.

The connection between the video recorder 21 and server 51 is established by the PLS server 65 described in FIG. 2, and information acquired by the digital pen 10 is sent to the server 51. The server 51 comprises a processing module 52, storage unit 54 and communication interface 55.

The processing unit 52 includes a program information conversion processing module 53 and a pen input analysis unit 56. The storage unit 54 stores the data 50, user data and log data for program information conversion. The communication interface 55 communicates with the video recorder via the network 5.

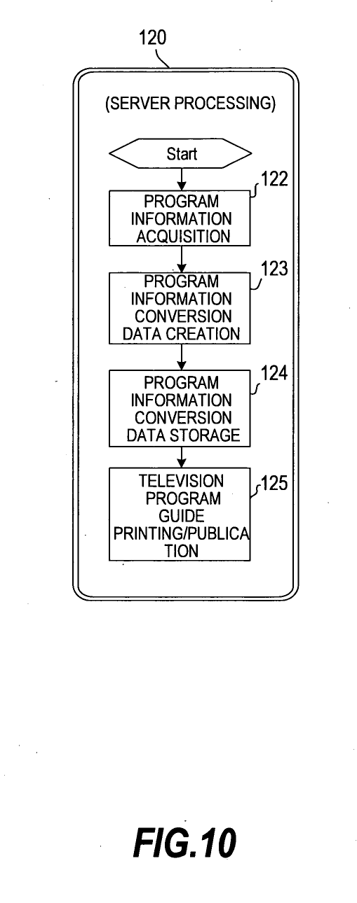

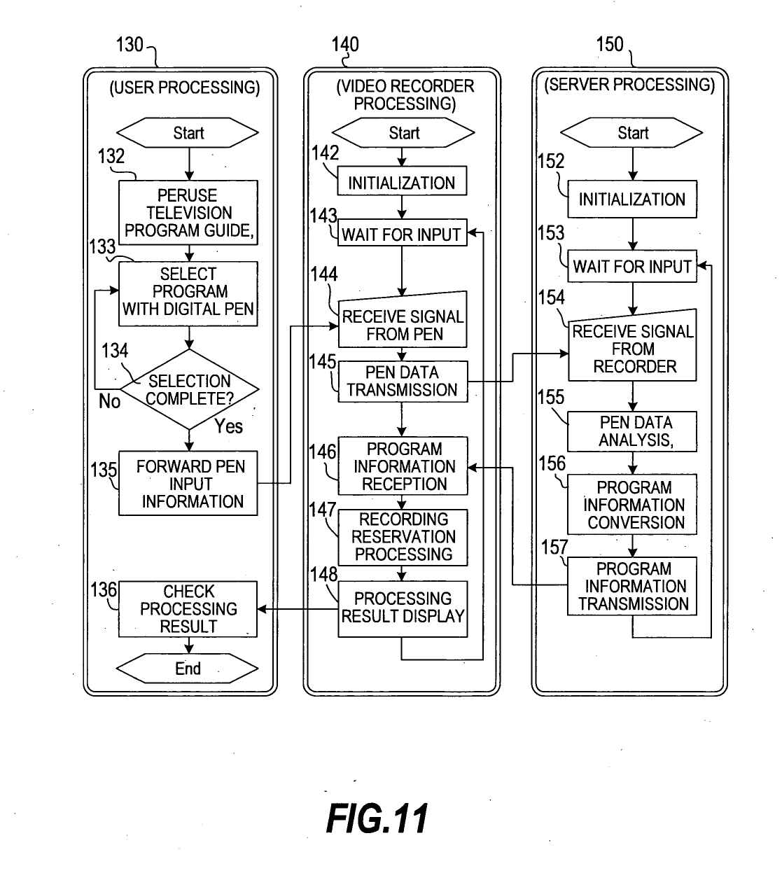

Next, referring to FIG. 10 and FIG. 11, an outline of the processing performed by this system will be described.

FIG. 10 is a flow diagram of a television program guide issue procedure in this system. The processing shown in FIG. 10 is processing executed by the server 51 of the program information center 4.

First, when processing starts (121), the server 51 synchronizes with a server (e.g., EPG server) which is the source of the program information obtained via the network 5, and acquires program information (122). Based on the acquired program information, the program information conversion data 50 to associate a position in the program schedule 40- with program information is created (123). This program information conversion data 50 can be created by for example the aforesaid procedure described in FIG. 5.

The server 51 then stores the program information conversion data 50 (124), and prints it as a television program guide (125). The printed television program guide may be sold in bookstores together with ordinary program guide magazines, or distributed to users as a flier in newspapers.

FIG. 11 is a flow diagram of the recording reservation procedure after the television program guide of the first embodiment has been distributed to users.

The recording reservation processing of the first embodiment may be broadly divided into processing 130 by the user, processing 140 by the video recorder and processing 150 by the server.

The user 1 peruses the television program guide 41 in the user's home 2 or another location 3 (132), and selects the programs in which he is interested using the digital pen 10 (133). This program selection may employ the aforesaid method in FIG. 3 and FIG. 4.

When selection of the required programs by the user 1 is complete, the digital pen 10 is connected with the video recorder 21 by a means such as Bluetooth, and information acquired by the digital pen is forwarded to the video recorder 21 (135).

When the video recorder 21 receives the information from the pen (144), the server which is the connection destination is firstly determined by communication with the PLS server 65. Subsequently, information acquired by the digital pen 10 is transmitted to the determined server (the server 51 placed in the program information center 4) via the network 5 (145).

The server 51 receives information acquired by the digital pen 10 (154), analyzes digital pen trace data (155), converts pen gestures into commands if required, and acquires corresponding program information (156). The processing sequence of this server 51 may be the aforesaid processing of FIG. 6. Subsequently, the server 51 transmits the acquired program information to the video recorder 21 (157).

When the program information is received from the server 51 (146), the video recorder 21 completes the recording reservation based on the received program information (147). The processing result is output via the video display unit 27, and presented to the user 1 by the video display apparatus 30 (148).

Subsequently, when the user 1 confirms the processing result (136), the processing sequence is terminated (137).

### SECOND EMBODIMENT

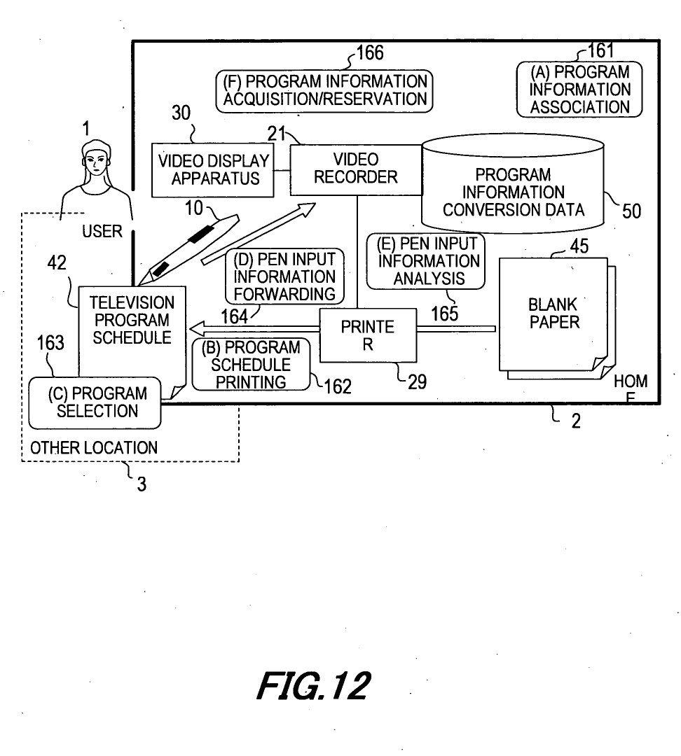

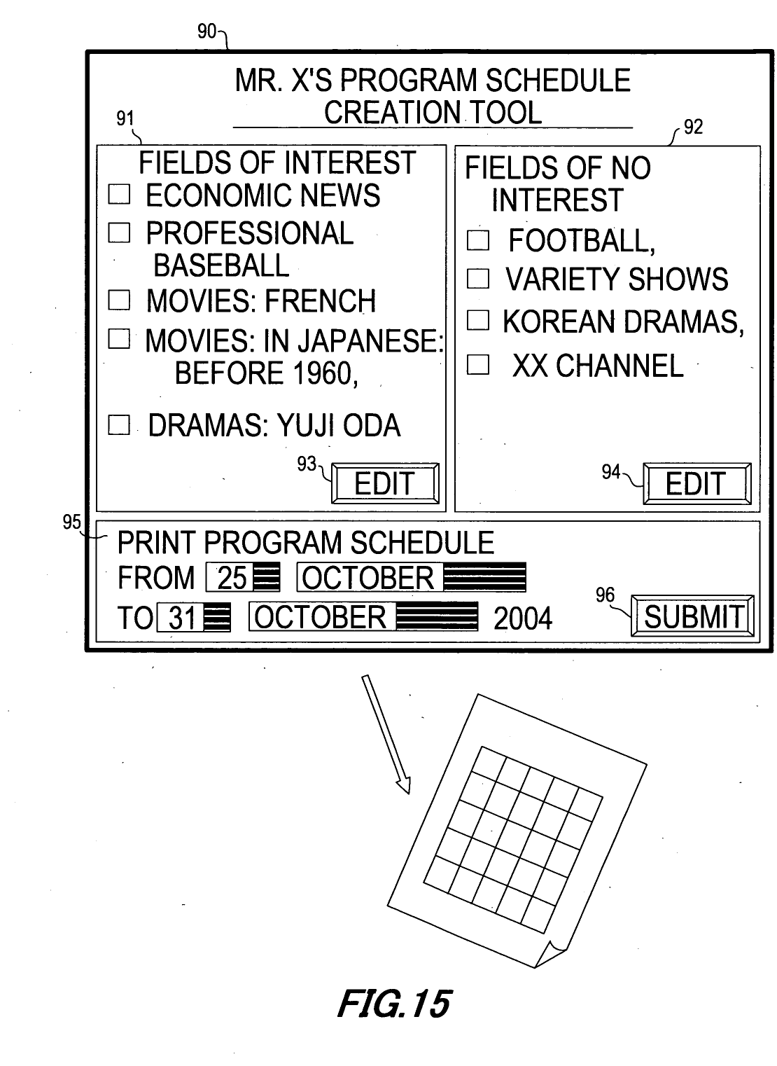

Referring to FIG. 12- FIG. 15, a second embodiment of this invention will now be described.

In the second embodiment, program data is downloaded to the video recorder beforehand, so there is no need to access the server of the program information center every time recordings are reserved or viewing programs are selected. Also, in the video recorder, a customized program schedule according to each user's preference and a recorded program list, can be output.

In the second embodiment, the same symbols are assigned to the same constructional elements as in the aforesaid first embodiment, and their detailed description is therefore omitted.

FIG. 12 is a system configuration diagram of the second embodiment.

The system of the second embodiment comprises a digital pen 10, a video recorder 21 corresponding to this system, an video display apparatus 30 such as a television or monitor, a storage device for storing the program information conversion data 50 connected to the video recorder 21, a printer 29, and a television program schedule 42 printed by the printer 29.

The program information conversion data 50 may be built into the video recorder 21 and kept in the home 2 of the user 1. Alternatively, it may be kept outside the home 2 and accessed via the network 5.

The printer 29 may be built into the video recorder 21, or externally connected to the video recorder 21. The video recorder 21 need not be a stand-alone product, but may be a personal computer connected to a tuner and connected to a recording medium (e.g., a hard disk drive and DVD disk drive).

Next, the processing of the service provided in the second embodiment will be described.

(A) The video recorder 21 acquires program information from a server (e.g., EPG server) which is the source of the program information via the network 5, and associates programs with the program information.

(B) The video recorder 21 prints a position detecting mark of the digital pen 10 and program schedule on a blank paper 45 by the printer 29 (162). The program schedule may also be printed on paper on which the position detecting mark has already been printed.

(C) The user 1 selects a program by marking it on the printed program schedule 42 using the digital pen 10. This program selection may be made by a method identical to that of the aforesaid first embodiment (FIG. 3 and FIG. 4).

(D) In the program selection operation, data acquired by the digital pen is stored in the digital pen 10, and forwarded to the video recorder 21 corresponding to this system with a suitable timing (164).

(E) The video recorder 21 analyzes the data acquired by the digital pen 10 (165), and converts the data acquired by the digital pen 10 into corresponding program information referring to the program information conversion data 50. Also, if required, pen gestures are converted into commands referring to the data 334 for pen gestures/commands.

(F) The video recorder 21 reserves the recording based on the obtained program information (166).

According to the second embodiment, since the user prints the program schedule, the latest program information can be acquired at any time. In addition, a customized program schedule according to user preferences can be made, so a program schedule which is easy to read and easy to select can be created. For example, a program in which a favorite actor appears can be printed out on the program schedule. The program schedule can be printed such that programs it is desired not to miss have been preselected. Conversely, the program schedule can be printed without printing genres and channel information which it is desired to avoid.

When the same video recorder is used by plural persons, by printing program schedules and selecting programs according to individual preferences, it is possible to identify who has reserved which programs, which is useful for looking up and retrieving recorded programs. To print program schedules according to individual preferences, user preferences and user histories can be stored in the database 54, different programs extracted for each user, and the program information conversion data 50 created for each user.

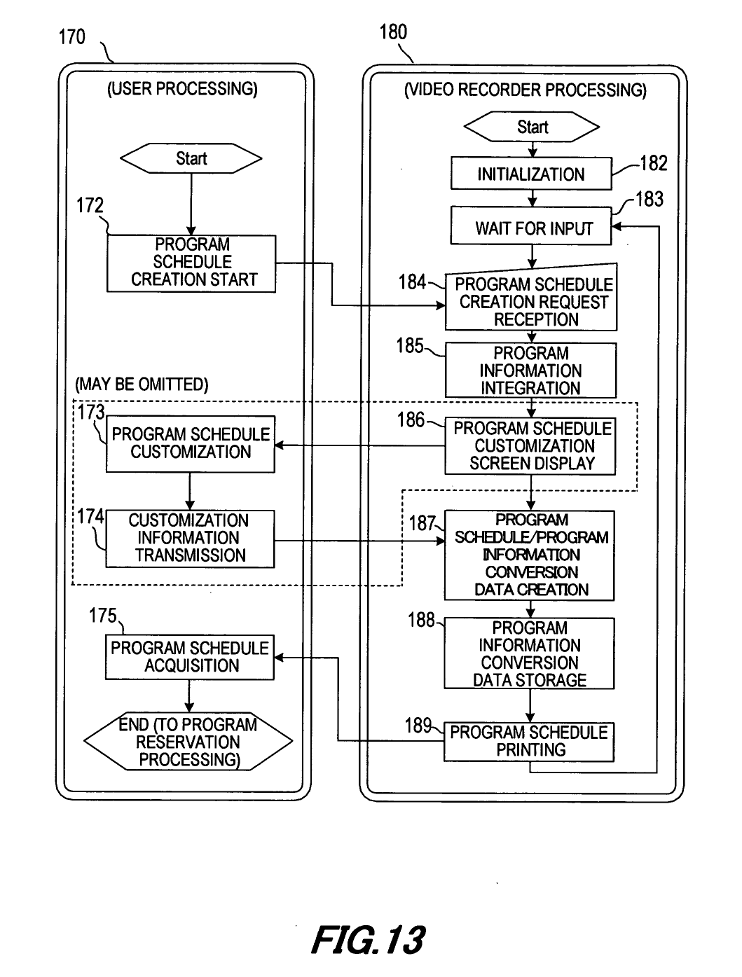

FIG. 13 is a flow diagram of the program schedule creation procedure of the second embodiment.

When the user 1 starts program schedule creation (172), the program data is installed in the video recorder 21 via the network 5 (185), and presents a program schedule customizing screen (186). The user 1 customizes the program schedule by using the displayed program schedule customizing screen (173), and transmits customization information to the video recorder (174).

The video recorder 21 creates the program schedule 42 and program information conversion data 50 based on the received customization information (187). This program schedule 42 and program information conversion data 50 can be created for example by an identical method to that of the first embodiment (FIG. 5). The created program information is stored (188), and the program schedule is printed on the paper 45 based on the created program information (189).

The user 1 obtains the printed program schedule 42 (175), and continues to perform program reservation processes. However, customized processing (186, 173, 174) is not indispensable to this system, and an ordinary usual program schedule which is not customized may also be printed.

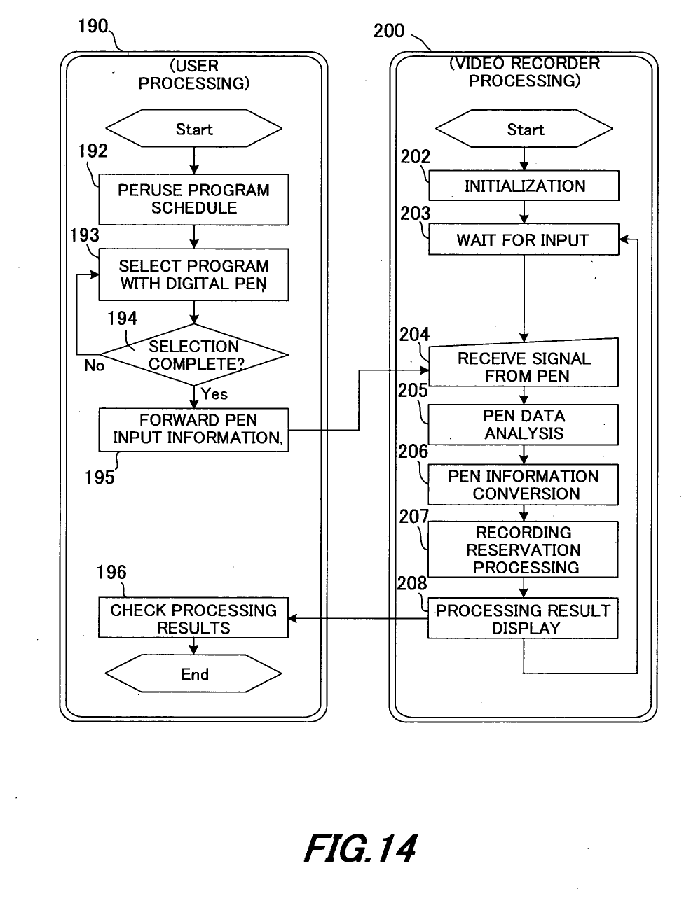

FIG. 14 is a flow diagram of the recording reservation process according to the second embodiment.

The recording reservation process of the second embodiment is almost identical to that of the first embodiment shown in FIG. 11, but the step for conversion to program information on the video recorder 21 side is different. The program information conversion data 50, which is created in the program schedule generation procedure shown in FIG. 13, can also be transmitted to the server, and program information conversion performed by the server.

FIG. 15 is an example of a screen for program schedule customization displayed in step 173 of the program schedule creation procedure of the second embodiment.

A screen 90 for program schedule customization is output via the video display unit 27, and displayed on a display apparatus such as a television or the monitor of a personal computer.

The screen 90 for program schedule customization includes a column 91 where the user sets fields in which he is interested, and a column 92 where the user sets fields in which he is not interested. The content set by these procedures is saved in a memory 22 of the video recorder 21 as user data 54. The saved user data can be modified by edit buttons 93 and 94.

The screen 90 for program schedule customization includes a column 95 where the date (range) for printing the program schedule is set. By specifying this date column 95, today's program schedule, tomorrow's program schedule and one week of program schedules can be selected for printing. When an execution button 96 is pushed, print is executed. Programs in fields marked as interesting which were set in column 91, can be printed to stand out. Also, programs in fields marked as uninteresting which were set in column 92, can be excluded from the print-out.

### THIRD EMBODIMENT

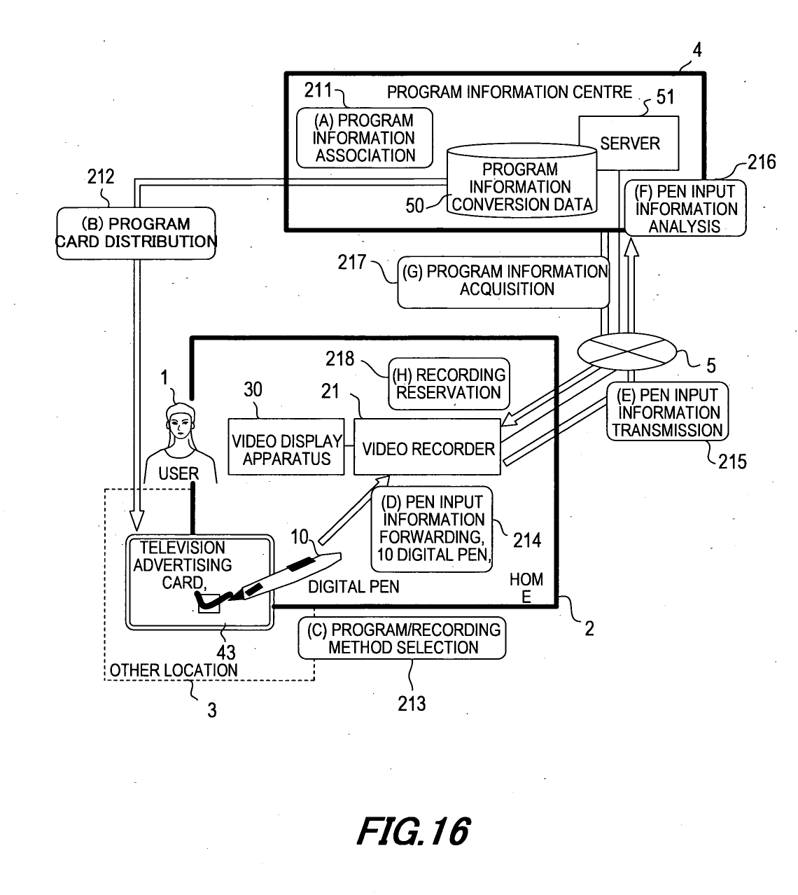

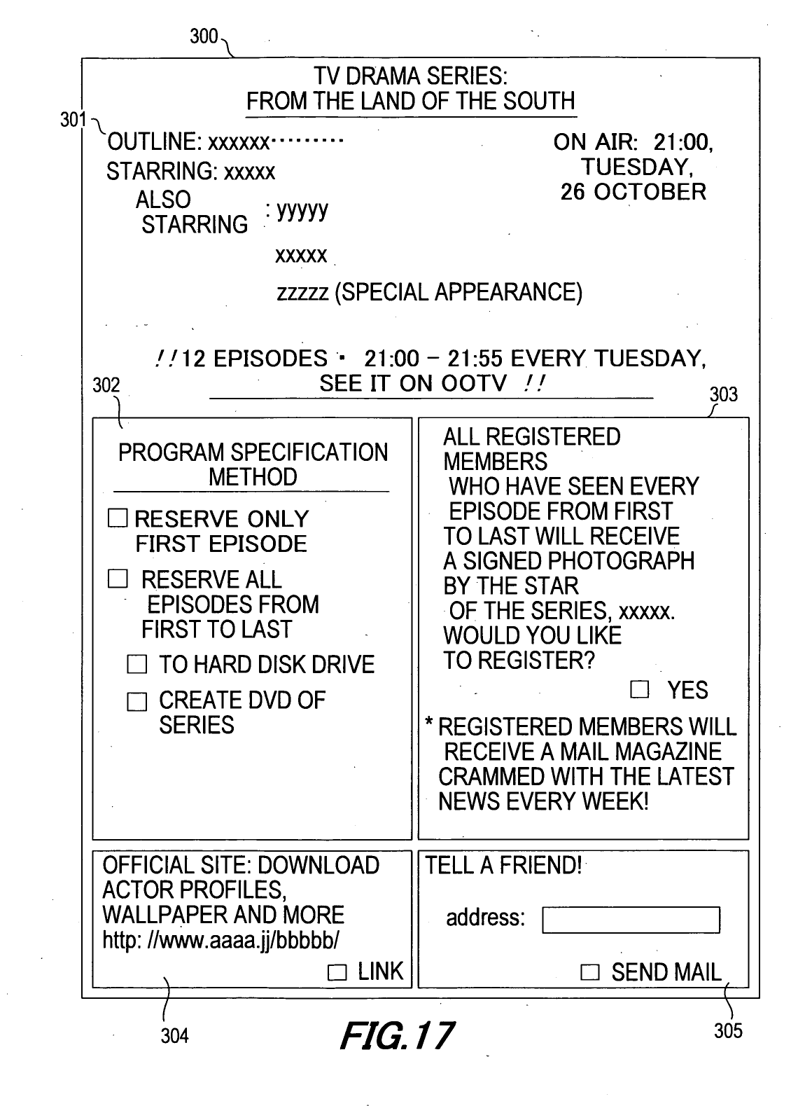

Next, referring to FIG. 16 and FIG. 17, a third embodiment of the present invention will be described. FIG. 16 is a system configuration diagram of the third embodiment of the present invention.

In the system of the third embodiment, as in the first embodiment, it is assumed that the program schedule is supplied from outside, but instead of-distributing it in the form of a magazine, it is distributed as a card or flier advertising the programs. Of course, it can also be distributed as a supplement to a magazine.

In the third embodiment, the same symbols are assigned to the same constructional elements as in the aforesaid first and second embodiments, and their detailed description is therefore omitted.

FIG. 17 shows an example of a program advertising card according to the third embodiment.

This card 300 contains program information 301, for example outline, actors and broadcasting time, a column 302 which sets the reservation specification method, a member registration column 303, a link column 304 and a mail column 305. The reservation specification method setting column 302 permits selection of whether the recording of the first episode is to be reserved, or whether all episodes from first to last are to be reserved together simply by checking the card. The storage destination of the program can also be specified, or creation of a series of DVD can also be set.

The member registration column 303 is a column where member registration in the nature of a program fan club can be performed. If a server 451 gathers logs of which programs were recorded, a service can be provided to send presents to viewers who have seen all episodes. In this way, audience rating can be improved. Moreover, program producers and sponsors can understand the viewer layer, easily collect opinions from viewers and-do interactive program-making.

By using the web link function and mail sending function of the digital pen 10, inducements can be given to visit an official site (304), or send mail to tell a friend about the program (305).

### FOURTH EMBODIMENT

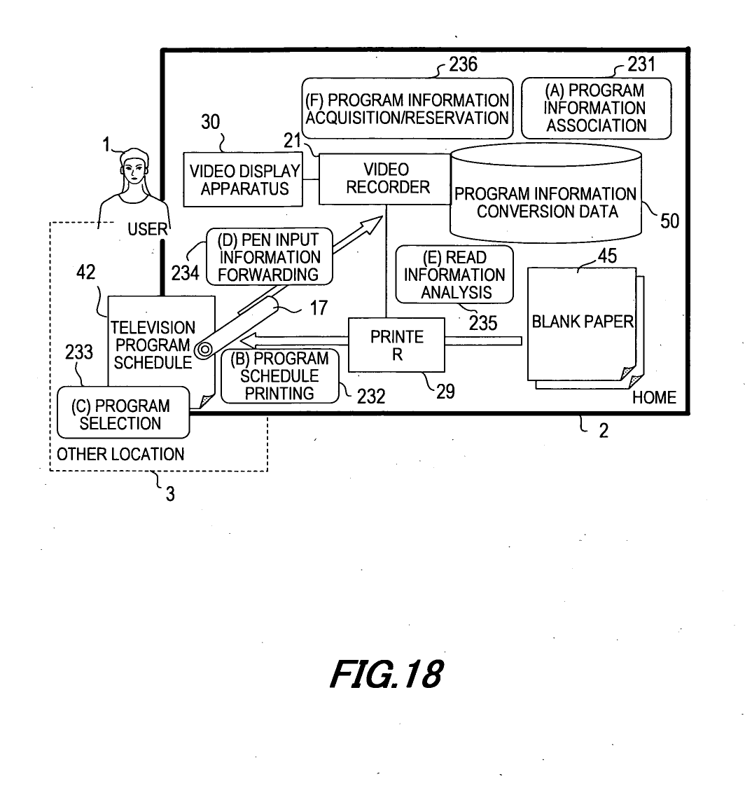

Next, referring to FIG. 18, a fourth embodiment of the invention will now be described.

FIG. 18 is a system configuration diagram of the fourth embodiment.

The fourth embodiment is similar to the aforesaid second embodiment, but instead of the digital pen 10, programs are specified by a terminal (e.g., a camphone or bar-code reader) having a picture-taking module. A mark to specify a position is placed on a printed program schedule. This mark is used to recognize a position on paper with the camera regardless of whether it is a shape which can or cannot be recognized by the human eye.

In the fourth embodiment, the same symbols are assigned to the same constructional elements as in the aforesaid first to third embodiments, and their detailed description is therefore omitted.

Next, the processing of the service provided by the fourth embodiment will be described.

(A) The video recorder 21 acquires program information from a server (e.g., EPG server) which is the source of the program information via the network 5, and associates a program with program information(231).

(B) The video recorder 21 prints the program schedule on blank paper, or the paper 45 on which the position specifying mark has been printed beforehand by the printer 29 (232).

(C) The user 1 selects a program by taking a picture of the printed program schedule 42 with the camera terminal 17 (233).

(D) The terminal 17 forwards the acquired information to the video recorder 21 (234).

(E) The video recorder 21 analyzes the forwarded information (235), looks up the program information conversion data 50, and converts information acquired by the terminal 17 to corresponding program information.

(F) The video recorder 21 reserves the recording based on the obtained program information.

The same processing can be performed by a personal computer connected to a tuner and the printer 29 instead of the video recorder 21.

According to the fourth embodiment, programs can be recorded and the viewing method set by a device familiar to the user instead of a special device like the digital pen 10.

### FIFTH EMBODIMENT

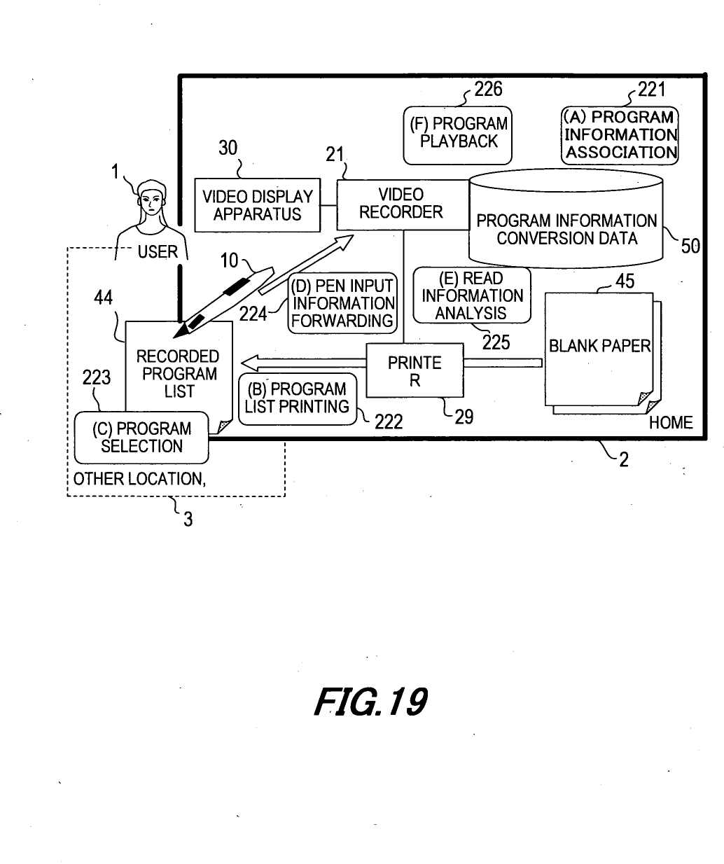

Next, referring to FIG. 19, a fifth embodiment of the invention will be described.

FIG. 19 is a system configuration diagram of the fifth embodiment.

The construction of the fifth embodiment is almost identical to that of the second aforesaid embodiment, but in the fifth embodiment, instead of specifying a program to be recorded, a list of programs which have already been recorded by the video recorder 21 is output, and the programs to be viewed among the programs recorded by the video recorder 21 and the viewing method, are specified.

In the fifth embodiment, the same symbols are assigned to the same constructional elements as in the aforesaid first to fourth embodiments, and their detailed description is therefore omitted.

Next, the processing of the service provided by the fifth embodiment will be described.

(A) The video recorder 21 selects program information in the list from among the recorded programs stored in the storage unit 22. An association is made between the selected program information and a printed position on the program schedule (221), the program information conversion data 50 is created, and stored in the storage unit 22.

(B) The video recorder 21 prints a position detection mark and program schedule on the paper 45 by the printer 29 (222). As in the second embodiment, the paper used for the digital pen 10 on which the position detection mark has already been printed, may also be used.

(C) The user 1 selects the program by marking it using the digital pen 10 on a printed program list 44. This program can be selected by an identical method to that of the aforesaid first embodiment (FIG. 3 and FIG. 4). The method of viewing the program is also set (223).

(D) In the program selection operation, the data acquired by the digital pen is stored by the digital pen 10, and transferred to the video recorder 21 corresponding to the system with a suitable timing (224).

(E) The video recorder 21 analyzes the data acquired by the digital pen 10 (225), looks up the program information conversion data 50, and converts the data acquired by the digital pen 10 into corresponding program information.

(F) The video recorder 21 plays back the program (226) based on the obtained program information.

At this time, a detailed setting can be performed, i.e., the program list can be printed according to the date or genre, or only programs which have not yet been seen can be selected and printed.

According to the fifth embodiment, the problem of the user losing sight of many recorded programs and not knowing which to view, is solved, and programs can be viewed easily.

### SIXTH EMBODIMENT

Next, referring to FIG. 1 and FIG. 2, a sixth embodiment of the invention will be described.

The sixth embodiment further expands on the fifth embodiment, permitting selection of other material in addition to television programs. In the sixth embodiment, the same symbols are assigned to the same constructional elements as in the aforesaid first to fifth embodiments, and their detailed description is therefore omitted.

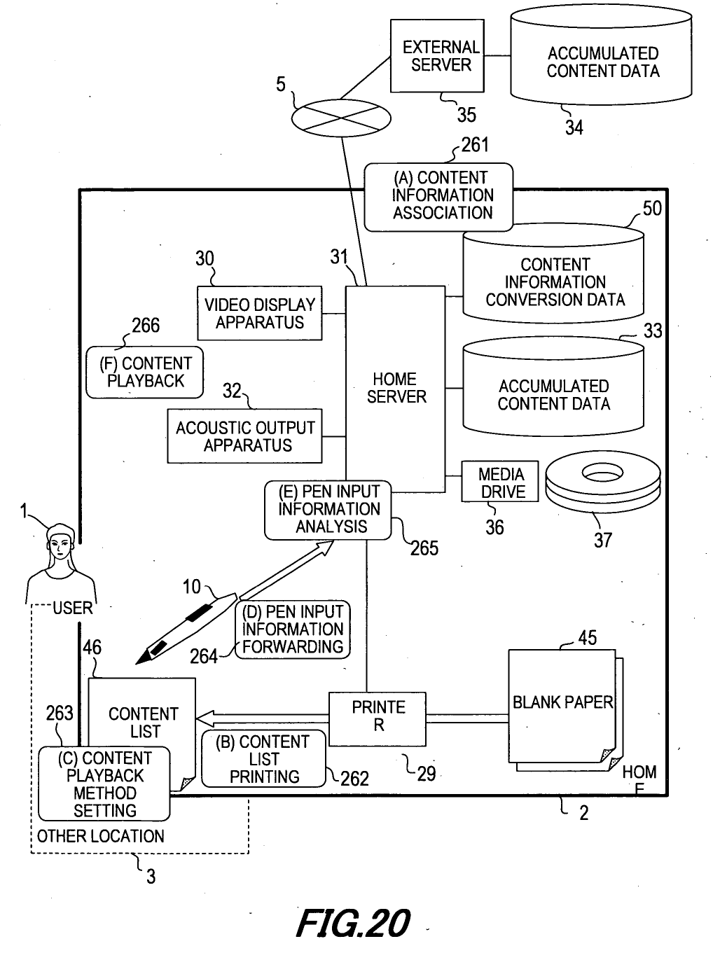

FIG. 20 is a system configuration diagram of the sixth embodiment.

In the system of the sixth embodiment, the viewing (playback) object is not only television programs, but various kinds of content inside and outside the home. For example, in addition to recorded television programs, various other content including accumulated data 33 such as stored music files, picture data taken by digital cameras or video and image data, content stored on media 37 such as DVD, video and CD, and streaming data received from an external server 35 via the Internet, are managed by a home server 31.

Next, the processing of the service provided by the sixth embodiment will be described.

(A) The home server 31, after customization and filtering of the accumulated local data 33, content data 37 in media and accumulated data stored externally as required, creates a content list. At this time, associations are created between the content and position information on paper (261).

(B) The home server 31 prints the content list on the paper 45 by the printer 29 (262).

(C) The user 1 sets the playback content, the content playback sequence and the content playback method by marking with the digital pen 10 on a printed content list 46 (263). This playback content can be selected by an identical method to that of the aforesaid first embodiment (FIG. 3 and FIG. 4).

(D) The data acquired by the digital pen is stored by the digital pen 10, and forwarded to the home server 31 with a suitable timing (264).

(E) The home server 31 analyzes the data acquired by the digital pen 10 (265), looks up the program information conversion data 50, and acquires the content corresponding to the data acquired by the digital pen 10. Also, if required, it looks up the pen gesture/command correspondence data 334, and converts pen gestures to commands.

(F) The home server 31 plays back the acquired content using the display unit 30 and acoustic output apparatus 32 (266).

According to the sixth embodiment, even if the management of a large amount of varied content is a complex affair, this content can be treated in bulk. Moreover, even a user who is inexperienced in manipulating devices can easily enjoy the content.

### SEVENTH EMBODIMENT

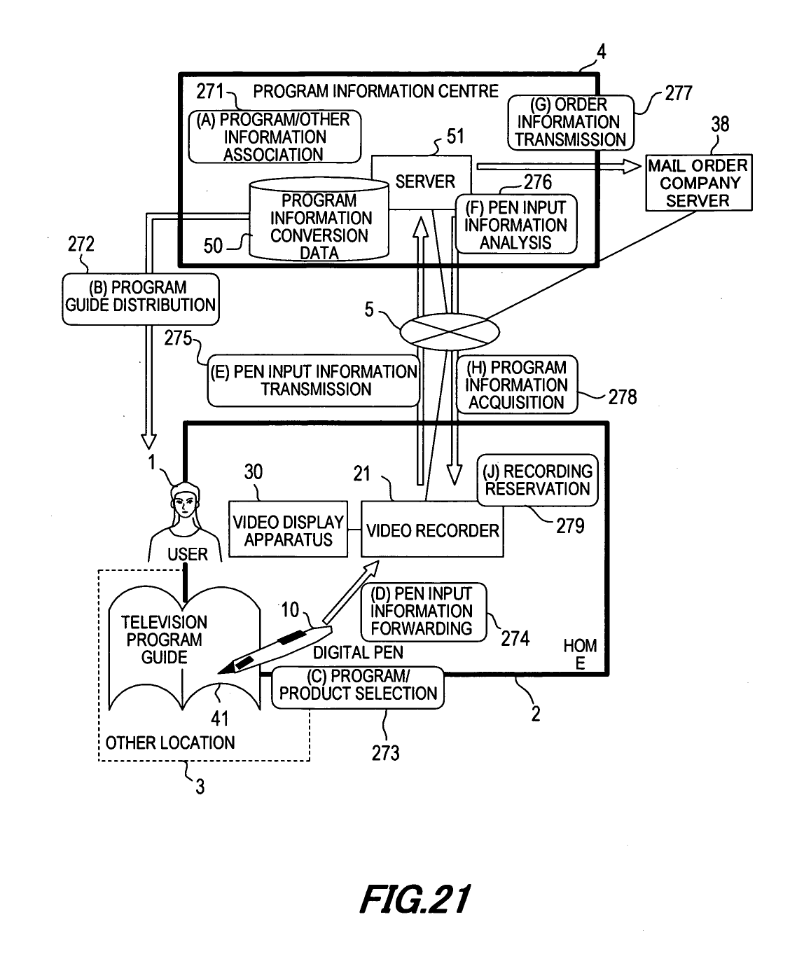

Next, referring to FIG. 21, a seventh embodiment of the present invention will be described.

In the seventh embodiment, an ordering function such as mail order is added to the function of television program reservation. In the seventh embodiment, the same symbols are assigned to the same constructional elements as in the aforesaid first to sixth embodiments, and their detailed description is therefore omitted.

FIG. 21 shows the system of the seventh embodiment.

In the system of the seventh embodiment, the television program guide 41 is used as in the aforesaid first embodiment, but it can be applied also to the example where the user prints the program schedule as in the second embodiment.

Next, the processing of the service provided by the seventh embodiment will be described.

(A) When an association is made with program information that uses the program information conversion data 50, the server 51 makes associations for position information not only with program information, but also with advertising information or mail order product information printed on each page (271).

(B) After these associations are created, the server 51 prints the program guide and distributes it to the user (272).

(C) The user 1 checks the program, products and advertisements using the television program guide 41 and digital pen 10 as in the aforesaid embodiment (273).

(D) The data acquired by the digital pen is stored by the digital pen 10, and forwarded to the video recorder 21 with a suitable timing (274).

(E) The video recorder 21 transmits the data acquired by the digital pen 10 to the server 51 via the network 5 (275).

(F) The server 51 analyzes the data acquired by the digital pen 10, looks up predetermined input rules and the program information conversion data 50, and the program to be recorded or products to be ordered are determined corresponding to the input.

(G) If the data acquired by the digital pen 10 is an order for a product, the ordering information is transmitted to a mail order business person's server 38 (277).

(H) If the data acquired by the digital pen 10 is a program reservation, program information is transmitted the to video recorder 21 (278).

(J) The video recorder 21 reserves the recording based on the received data (279).

According to the seventh embodiment, the user can readily order a product by mail order by a simple procedure on the same platform as that used for checking television programs. Therefore, user convenience is improved.

From a sponsor's viewpoint, advertising impact can be increased by targeting a range of customers interested in a certain specific program.

Also, by gathering log data for the program information conversion server 51, customers can be managed by making associations between buying behavior and viewing behavior, which has a wide range of application.

According to the present invention, a video recorder that offers improved convenience can be provided. Further, a system which simplifies the viewing of a large amount of recorded programs and content management can be provided, and by means of this system, these services are provided to the user.

For a television program producer or sponsor, a platform for business development such as advertising and mail order can be provided. Studies can be made of how a television program is viewed by the general public, and an understanding gained of the viewers. Further, interactive program-making which takes viewers' opinions into account, can be performed.

While the present invention has been described in detail and pictorially in the accompanying drawings, the present invention is not limited to such detail but covers various obvious modifications and equivalent arrangements, which fall within the purview of the appended claims.

What is claimed is:

1. A video recorder having a storage unit which stores program content including an image, a communications unit which receives an input designating a position on a paper on which program information is printed, and a control unit which connects the storage unit with the communications unit, wherein:
the control unit:
specifies, based on a position designated on the paper, a program identifier by looking up a correlation between a position on the paper and the program identifier;
reserves a recording of the program containing the specified program identifier; and
stores the program content is input via a tuner and the recording in the storage unit, or outputs, to an video display apparatus, the program content having the specified program identifier selected from the storage unit.

2. The video recorder according to claim 1, wherein:
the control unit:
accesses a program information server which stores the correlation between the position on the paper and program identifier via the communications unit; and
obtains the specified program identifier from the program information server based on the designated position on paper.

3. The video recorder according to claim 1, wherein the storage unit stores the correlation between the position on paper and the program information.

4. The video recorder according to claim 1, wherein:
the communications unit receives a signal showing a trace on paper on which the program information is printed, and
the control unit:
specifies an operating command which is pre-assigned to the trace based on the received signal showing the trace; and
performs at least one of the actions, referring to the correlation between the position on paper and the program identifier, recording the program content and outputting the program content, based on the designated position and the specified operating command.

5. The video recorder according to claim 4, wherein the operating command includes at least one of an operating command which selects plural programs together, an operating command which instructs recording to take place until the end of the program transmission regardless of the scheduled program transmission time, a command which selects a program corresponding to program information printed at a position surrounded by the trace, a command which instructs a viewing sequence of plural programs, a command which invalids any one of the previous inputs, and a command which specifies a method of playing back the program content.

6. The video recorder according to claim 1, wherein the control unit:
stores information showing each user's preference in the storage unit;
selects a program from the program information according to each user's preference;
creates a correlation between the selected program and the position on paper, and stores the correlation for each user in the storage unit; and
outputs data for printing a program schedule based on the correlation for each user.

7. A method of managing program content in a video recorder, the recorder having a storage unit, a communications unit which receives an input, and a control unit which connects the storage unit with the communications unit, and the method comprising the steps of:
receiving, by the communications. unit, an input designating a position on a paper on which program information is printed;
specifying, by the control unit, a program identifier by referring to a correlation between a predetermined position on the paper and the program identifier; and
reserving, by the control unit, a recording of the program containing the specified program identifier to obtain the program content via a tuner and the recording in the storage unit, or outputting, to an video display apparatus, the program content having the specified program identifier selected from the storage unit.

8. The method of managing program content according to claim 7, further comprising the steps of:
accessing, by the control unit, a program information server which stores the correlation between the position on paper and program identifier; and
obtaining, by the control unit, program identifier from the program information server based on the designated position on the paper.

9. The method of managing program content according to claim 7, further comprising the step of storing, by the control unit, the correlation between the position on paper and the program information.

10. The method of managing program content according to claim 7, further comprising the steps of:
receiving, by the communication unit, a signal showing a trace on a paper on which the program information is printed;
specifying, by the control unit, an operating command which is pre-assigned to the trace based on the received signal showing the trace; and
performing by the control unit, at least one of the actions referring to the correlation between the position on paper and the program identifier, recording the program content and outputting the program content, based on the designated position and the specified operating command.

11. The method of managing program content according to claim 10, wherein the operating command includes at least one of an operating command which selects plural programs together, an operating command which instructs recording to take place until the end of the program transmission regardless of the scheduled program transmission time, a command which selects a program corresponding to program information printed at a position surrounded by the trace, a command which instructs a viewing sequence of plural programs, a command which invalids any one of the previous inputs, and a command which specifies a method of playing back the program content.

12. The method of managing program content according to claim 7, further comprising the steps of:
storing, by the control unit, information showing each user's preference in the storage unit;
selecting, by the control unit, the program information according to each user's preference;
creating a correlation between the selected program and the position on paper;
storing the correlation for each user in the storage unit; and
outputting data for printing a program schedule based on the correlation for each user.

13. A program information supply method using a video recorder, a program database and a program information server connected via a network, comprising the steps of:
accessing the program database to obtain program data including a program identifier;
creating program information conversion data containing a correlation coefficient between a position on a paper on which program information is printed and a program identifier;
storing the created program information conversion data; and
performing at least one of the actions outputting to the video recorder the program information converted the position on paper input from the video recorder based on the program information conversion data and transferring the program information conversion data to the video recorder.

14. The program information supply method according to claim 13, further comprising the steps of:
receiving a signal showing a trace on a paper from a video recorder;
specifying an operating command which is pre-assigned to the trace based on the received signal showing the trace ; and
outputting the program identifier specified by the designated position and the operating command to the video recorder.

15. The program information supply method according to claim 14, wherein the operating command includes at least one of an operating command which selects plural programs together, an operating command which instructs recording to take place until the end of the program transmission regardless of the scheduled program transmission time, a command which selects a program corresponding to program information printed at a position surrounded by the trace, a command which instructs a viewing sequence of plural programs, a command which invalids any one of the previous inputs, and a command which specifies a method of playing back the program content.

16. The program information supply method according to claim 13, further comprising the steps of:
creating a program schedule based on the program information conversion data; and
outputting data for printing the created program schedule.

17. The program information supply method according to claim 16, wherein the program schedule printed by the printing data is distributed on the paper for selecting a program whereby a user designates a position via the video recorder.

18. The program information supply method according to claim 17, wherein:
the program is provided by a television broadcast, and its content is stored in the video recorder; and
the program schedule, in addition to the program information, is stored in the program information server, and product or service information which is made to correspond with a position on the printed paper, is printed.

19. The program information supply method according to claim 18, comprising the steps of:
receiving a signal showing a position on a paper via the video recorder; and
transferring order information to a product or service provision server which provides the product or service via a network when it is determined that the position on the paper designated by the input based on the correlation is the product or a service.
